(19) United States
(12) Patent Application Publication
(10) Pub. No.: US 2012/0084212 A1
(43) Pub. Date: Apr. 5, 2012

(54) Method and Apparatus for Efficient Implementation of Design Changes

(75) Inventors: Lawrence Allen Sinor, Conroe, TX (US); Eric Paulsen, Stavanger (NO); David West, The Woodlands, TX (US)

(73) Assignee: BAKER HUGHES INCORPORATED, Houston, TX (US)

(21) Appl. No.: 13/252,172

(22) Filed: Oct. 3, 2011

Related U.S. Application Data
(60) Provisional application No. 61/390,177, filed on Oct. 5, 2010.

(51) Int. Cl. G06Q 10/00

(52) U.S. Cl. 705/300

(57) ABSTRACT

The disclosed embodiments allow a user to request new product designs and design changes remotely. The requested design or change is then submitted to a network-based automated process. The process may be remotely accessed by the user through a network connection. In one embodiment, the user may meet directly with a customer, pull up the specifications for the product in question, select a design or change desired by the customer, and submit the design or change. The process works in the background to validate the requested design according to one or more validation rules and/or best practices, and completes many of the necessary tasks to allow the requested design to proceed to manufacturing. Once the process has successfully completed the requested change, a notification is sent to the user containing information about the new or changed product, such as the new part number, order number, and the like.

### CROSS REFERENCE TO RELATED APPLICATIONS

This application claims the benefit of priority from U.S. Provisional Application No. 61/390,177, entitled “Method and Apparatus for Efficient Implementation of Design Changes,” filed Oct. 5, 2010, which provisional application is hereby incorporated by reference in its entirety.

### STATEMENT REGARDING FEDERALLY SPONSORED RESEARCH

Not applicable.

### REFERENCE TO APPENDIX

Not applicable.

### BACKGROUND OF THE INVENTION

1. Field of the Invention

This disclosure relates generally to methods and apparatuses for more efficiently implementing new product designs and design changes. The disclosure relates specifically to methods and apparatuses that allow new product designs and design changes to be submitted remotely to a network-based process that automatically performs all actions necessary for implementing the new designs or design changes, including completion of any business forms that may be required, so that the new designs or design changes may proceed directly to manufacturing.

2. Description of the Related Art

Currently, developing a new product or changing an existing product is a timely and expensive effort. Much of the high costs and long lead times may be attributable to work that needs to be done by CAD (computer-aided design) designers and CAM (computer-aided manufacturing) specialists before the new design or design change can proceed to manufacturing. However, a large company or corporation may produce hundreds if not thousands of new product designs and design changes a year. As a result of the workload, access to the CAD designers and CAM specialists may be limited, thereby creating a bottleneck in the product delivery cycle.

FIG. 1 illustrates an example of an existing delivery cycle 100, where a new design or design change is requested by a customer through a salesperson or a field engineer at 102. The new design or design change is placed in a queue to await prioritization and access to a CAD designer at 104. Once the CAD designer completes the CAD work, the request is placed in another queue to await prioritization and access to a CAM specialist and the NC (numerically controlled) machines and equipment that are used to manufacture the product are programmed at 106. Once that work is completed, layout drawings reflecting the requested design or design change are prepared at 108, and any necessary data, such as routings and bill of materials are entered at 110. The new design or design change is thereafter produced by the manufacturing plant at 112 and subsequently delivered to the customer at 114.

The above queues and associated work and documentation therefor often add days, weeks or even months to the process from the time the new design or design change is selected until the product is delivered to the customer. Compounding the delay, many new designs or design changes require engineers to study and evaluate the proposed changes, including validations, studies, and other calculations concerning the proposed the changes, before the changes are allowed to proceed. FIG. 2 illustrates an example of the timing and resulting delay that may be incurred, for example, to change the design of typical fixed cutter drill bit used in the oilfield industry following the process shown in FIG. 1. As can be seen in FIG. 2, in a typical scenario, the time from when a change in the drill bit is first requested until the beginning of the manufacturing cycle can be in excess of 30 days.

Accordingly, what is needed is an efficient method and apparatus for implementing new product designs and design changes. More specifically, what is needed is a method and apparatus that can automatically perform many of the actions required to implement new designs and design changes.

### SUMMARY OF THE INVENTION

The present disclosure relates to methods and apparatuses that allow a user, such as a customer, salesperson, or field engineer, to request new product designs and design changes remotely. The requested design or change is then submitted to a network-based automated process referred to herein as a “configurator.” The configurator may be remotely accessed by the customer, salesperson, or field engineer through a network connection, such as an intranet or the Internet. In one embodiment, the salesperson or engineer may meet directly with the customer, pull up the specifications for the product in question, select a design or change desired by the customer, and submit the design or change to the configurator. The configurator, working in the background, validates the requested design or change according to one or more validation rules and/or best practices, and completes all or many of the necessary tasks to allow the request to proceed on to manufacturing. Once the configurator has successfully completed implementing the requested change, a notification is sent or otherwise provided to the salesperson, engineer, and/or customer containing information about the new or changed product, such as the new part number, order number, and the like. In this way, little or no intervention is required by CAD, CAM, or other engineering or technical personnel to complete implementation of the new product design or design change. Such an arrangement helps greatly reduce the queue times for CAD, CAM, and other engineering functions associated with existing processes, thereby virtually eliminating the usual delays associated with such queue times.

Advantages of the methods and apparatuses disclosed herein may include automatic creation of unique three-dimensional (3-D) CAD models and drawings for each product design requested by the user. The methods and apparatuses disclosed herein may also create the CAM tool paths and NC tapes as required for the new bit design. In some embodiments, the disclosed methods and apparatuses may perform certain engineering checks and may limit on-the-fly the types of options and selections that may be made. In some embodiments, the disclosed methods and apparatuses may also calculate certain performance characteristics for the new design in real time or near real time while the user is configuring the new product design or design change. The ability of the disclosed methods and apparatuses to create a new and unique product by automatically leveraging a reference product can save a significant amount of engineering and administrative time, as only the work that is actually needed is performed. Similarly, the ability of the disclosed methods and apparatuses to automatically create unique 3-D models and drawings for each new design or design change, as well as allowing component to be swapped out, provides tremendous efficiencies over existing solutions. An additional benefit is the disclosed methods and apparatuses allow the usual queues to be bypassed in some instances, reducing the time needed to deliver not just a product, but an entire suite comprising potentially hundreds of variations of a base or reference design.

In general, in one aspect, the disclosed methods are directed to a method of implementing new product designs and design changes in real time. The method comprises, among other things, presenting a plurality of design parameters for a product that are available to be changed, receiving a selected design parameter to be changed from the plurality of design parameters, presenting a set of options to which the selected design parameter may be changed, and receiving a selected option from the set of options. The method further comprises automatically evaluating the selected option against one or more predefined validation rules and/or best practices, and automatically generating numerically controlled manufacturing information for the product, the numerically controlled manufacturing information reflecting the selected option, wherein the set of options to which the selected design parameter may be changed is derived from the selected design parameter.

In general, in another aspect, the disclosed apparatuses are directed to a system for allowing users to request new product designs and design changes from a remote location. The system comprises, among other things, a network accessible by a user from the remote location, a database connected to the network, the database storing design parameters for the product and options for each design parameter, and a server connected to the database. The server includes a processor and a storage medium storing computer-readable instructions that are executable by the processor for causing the server to, present a set of design parameters for the product that are available to be changed to the user, receive a selected design parameter to be changed from the set of design parameters from the user, present a set of options to which the selected design parameter may be changed to the user, and receive a selected option from the set of options from the user. The computer-readable instructions are further executable by the processor for causing the server to automatically evaluate the selected option against one or more predefined validation rules and/or best practices, and automatically generate numerically controlled manufacturing information for the product, the numerically controlled manufacturing information reflecting the selected option, wherein the set of options to which the selected design parameter may be changed is derived from the selected design parameter.

In general, in yet another aspect, the disclosed methods are directed to a method for allowing a user to generate new drill bit designs and drill bit design changes on-the-fly. The method comprises, among other things, presenting a plurality of drill bit design parameters that are available to be changed to the user, receiving a selected drill bit design parameter to be changed from the plurality of drill bit design parameters from the user, presenting a set of drill bit design options to which the selected drill bit design parameter may be changed to the user, and receiving a selected drill bit design option from the set of drill bit design options from the user. The method further comprises, among other things, evaluating the selected drill bit design option against one or more predefined drill bit design validation rules and/or best practices, and automatically generating numerically controlled manufacturing information for the drill bit, the numerically controlled manufacturing information reflecting the selected drill bit design option, wherein the set of drill bit design options to which the selected design parameter may be changed is derived from the selected drill bit design parameter.

In general, in still other aspects, the disclosed methods and apparatuses may be used to design a fixed cutter drill bit, and the plurality of design parameters may include the number of cutters per blade, type of cutters, backrake angle, cutter exposure, lateral movement mitigation, data bit module option, gage pattern, gage material, and rubbing for the drill bit. In general, in still other aspects, the disclosed methods and apparatuses may comprises presenting a plurality of design sub-parameters for the product that are available to be changed based on the selected design parameter, wherein each selected design parameter has a separate set of design sub-parameters associated therewith. In general, in still other aspects, the disclosed methods and apparatuses may comprise automatically generating a three-dimensional graphical representation of the product, the three-dimensional graphical representation reflecting the selected option. In general, in still other aspects, the selected option may be automatically evaluated against the one or more predefined validation rules and/or best practices based on an intended application of the product. In general, in still other aspects, the automatic evaluation may include making one or more options unavailable for selection based on the selected option and/or the selected design parameter. In general, in still other aspects, the automatic evaluation may include conducting a performance analysis for the drill bit based on the selected drill bit design option.

### BRIEF DESCRIPTION OF THE DRAWINGS

The foregoing and other advantages of the disclosed embodiments will become apparent from the following detailed description and upon reference to the drawings, wherein:

FIG. 1 illustrates an example of a prior art process of implementing new product designs and design changes;

FIG. 2 illustrates potential delays that may be incurred with the process of implementing new product designs and design changes shown in FIG. 1;

FIG. 3 illustrates an example of a process of implementing new product designs and design changes according to the disclosed embodiments;

FIG. 4 illustrates an exemplary system for a process of implementing new product designs and design changes according to the disclosed embodiments;

FIG. 5 illustrates an exemplary server for a process of implementing new product designs and design changes according to the disclosed embodiments;

FIG. 6 illustrates an exemplary flowchart for a process of implementing new product designs and design changes according to the disclosed embodiments; and

FIGS. 7-13 illustrate an exemplary interface for a process of implementing new product designs and design changes according to the disclosed embodiments.

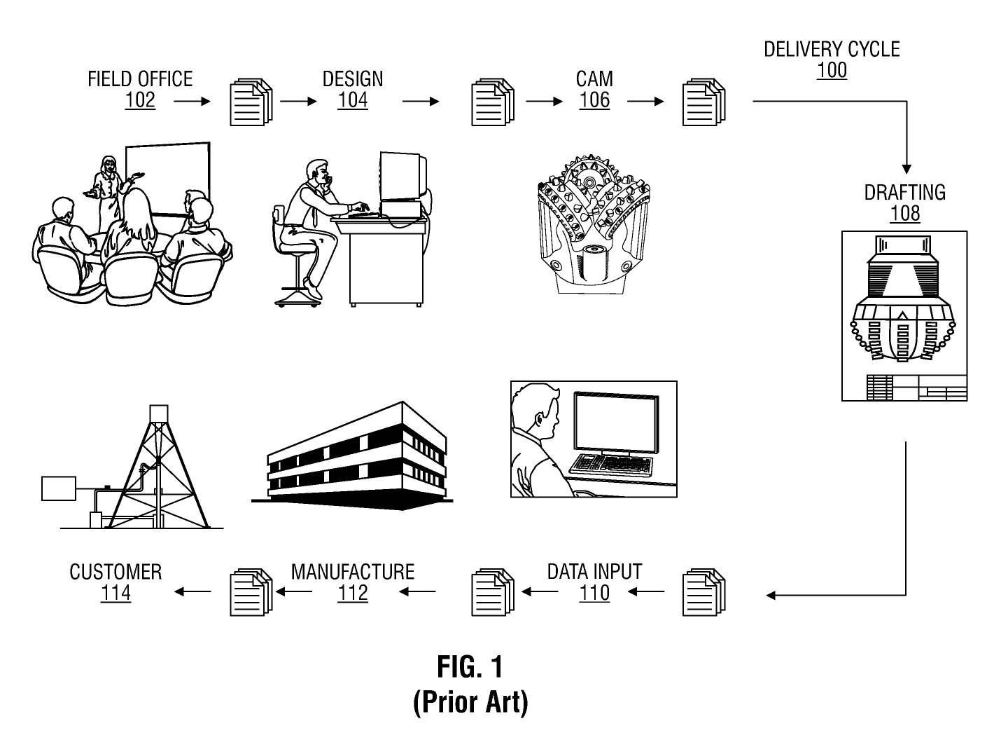

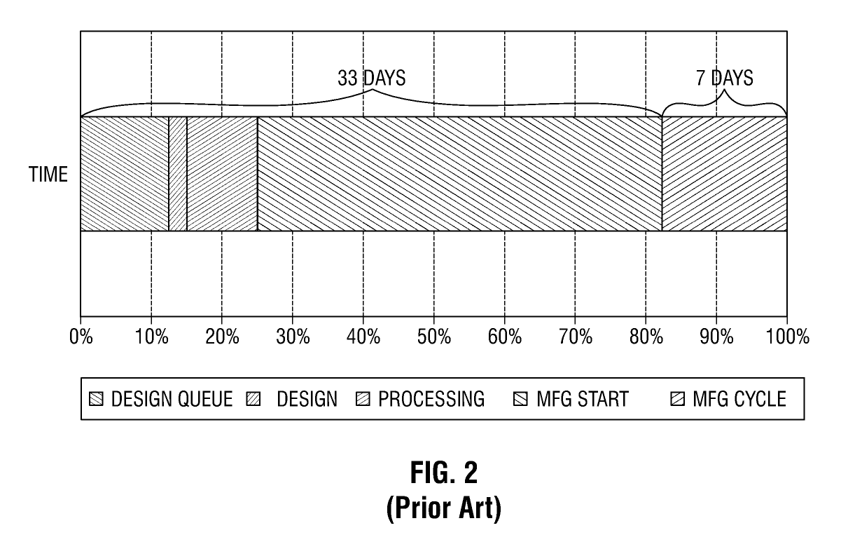

### DETAILED DESCRIPTION

The figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location, and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

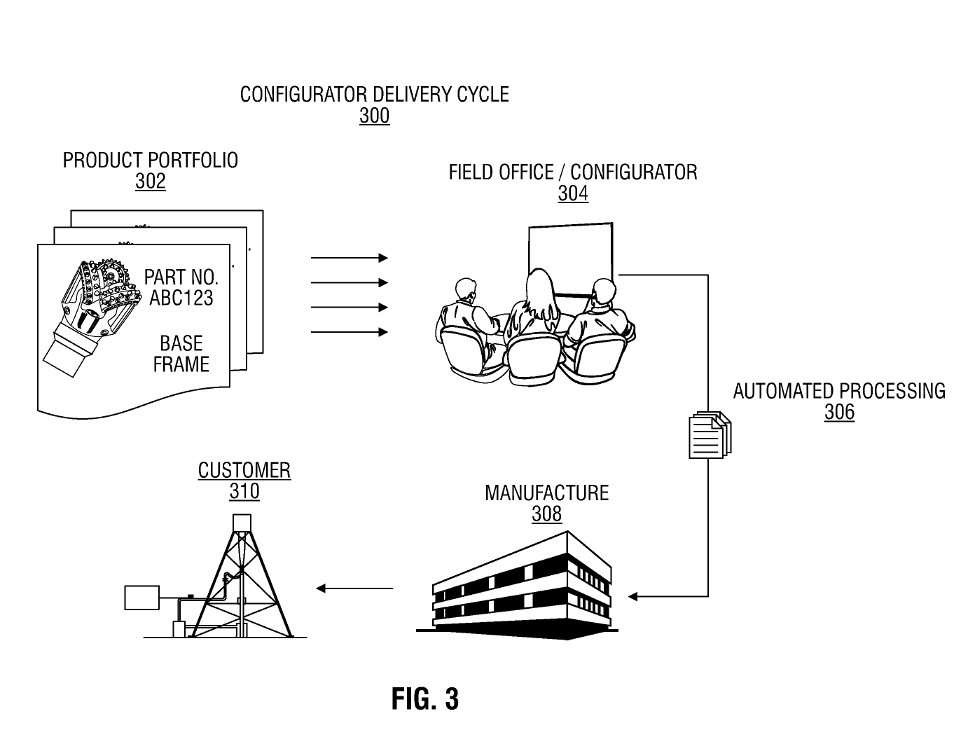

Referring now to one of many possible embodiments of the invention, FIG. 3 illustrates a delivery cycle 300 for implementing new product designs and design changes using a configurator of the present invention. As can be seen, the configurator allows a customer, salesperson, or field engineer, using an existing product portfolio, denoted at 302, to request new product designs and design changes remotely at 304. Such requests may be initiated from a field office, a customer's facility, or the like using the configurator's graphical user interface (discussed later herein). The configurator thereafter automatically performs, at 306, many of the actions required to implement the new design or design change. The term “automatically,” as used herein, means with little or no human intervention. Such actions include, but are not limited to, validation of the design or changes, generation of 3-D CAD models and drawings, CAM files, and tool paths for the machines and equipment that will be used to produce the product. The new design or design change may then be released directly to manufacturing at 308, resulting in faster and much more efficient delivery of the product to the customer at 310.

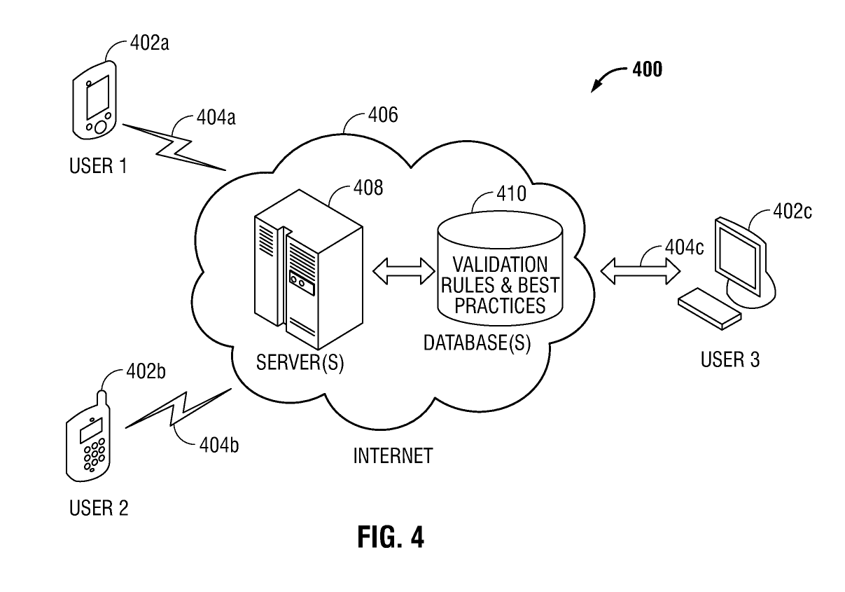

FIG. 4 illustrates an example of a system 400 on which the configurator may be implemented according to the disclosed embodiments. As can be seen, a plurality of remote computing devices 402a, 402b, and 402c are connected via network connections 404a, 404b, and 404c to a computing network 406. In the present example, the remote computing devices may be a smart phone, digital tablet, desktop computer, notebook computer, and similar remote computing and communication device, and the network connection may be wired and/or wireless connections. In a similar manner, the computing network 406 may be a private network such as a corporate intranet, or it may be a public network such as the Internet. One or more network servers 408 may be connected to the computing network 406 along with at least one database 410, which may be either an internal database, or a database that resides in a physically separate location from the network servers 408 (as shown here), depending on the constraints (e.g., size, speed, etc.) of the particular implementation. Note that the term “server” is used herein to include conventional servers as well as high-end computers, workstations, mainframes, supercomputers, and the like. In the present example, the one or more network servers 408 may include one or more Web servers that are individually or jointly capable of hosting a Web-based application over the computing network 406, and the at least one database 410 may be a relational database, operational database, or other suitable database capable of storing data and information for the Web-based application. The Web-based application, in accordance with the disclosed embodiments, is an automated process executed on the one or more servers 408 in the background referred to herein as the “configurator.”

In general operation, the configurator allows a user, such as a customer, salesperson, or field engineer, to request or initiate new product designs and design changes using the parameters of an existing product for reference. Such a configurator may be accessed via the remote computing devices 402a-c over the network connections 404a-c by entering the URL of the configurator into a Web browser running on the remote computing devices. A graphical user interface of the configurator allows the users to quickly and easily request a new design of a product or change an existing design of the product. The user uses the graphical user interface to select an existing product, then requests a new design or design change by selecting different options for one or more parameters of the existing product. These parameters may involve any parameter of the product that can be changed at manufacturing, provided the changes satisfy predefined validation rules and/or best practices for the product. In a fixed cutter drill bit, for example, the parameters may include the number of cutters per blade, type of cutters, cutter backrake angle, cutter exposure, lateral movement mitigation (LMM), gage length, gage pad pattern and gage material, and the like.

Validation of a given parameter may involve the configurator automatically limiting which options are available for that parameter or otherwise constraining the parameter. The configurator may also limit which parameters are subsequently available (i.e., sub-parameters) based on a previously selected parameter, as well as which options are selectable for these subsequent parameters. In some embodiments, validation may also be performed based on the intended application of the product. In the drill bit example, for instance, the user may identify a particular type of geological formation or lithology for the drill bit, such as clay, sandstone, shale, and the like, and the configurator may limit the available options based on the identified formation or lithology. The configurator may retrieve the validation rules and/or best practices from the at least one database 410, which may include existing repositories of knowledge, rules, and best practices accumulated over time. Alternatively, the configurator may generate the limitations and constraints in real time (or near real time) using engineering analysis techniques known to those having ordinary skill in the art, including computational fluid dynamics analysis, finite engineering analysis, kinematic modeling, and the like.

Once the parameters and various options therefor have been selected and validated, the configurator automatically generates 3-D CAD models and drawings for the requested design or design change. In one embodiment, the configurator may generate the CAD models and drawings by retrieving the CAD model and drawings for the reference product and determining which parameters have changed, modifying those parameter, and saving the modified CAD model and drawings as a new CAD model and drawings. The configurator thereafter generates a CAM file from the CAD model and drawings and prepares layout drawings and tool paths accordingly for forwarding to manufacturing. A notification is thereafter provided through the user interface and/or in an e-mail message informing the user that the requested design or design change have been completed. In the event that a problem with the design or design change is uncovered during the CAD, CAM, or subsequent process, the configurator may provide notification to the user indicating that the requested design or design change needs to be reviewed further by appropriate engineering personnel.

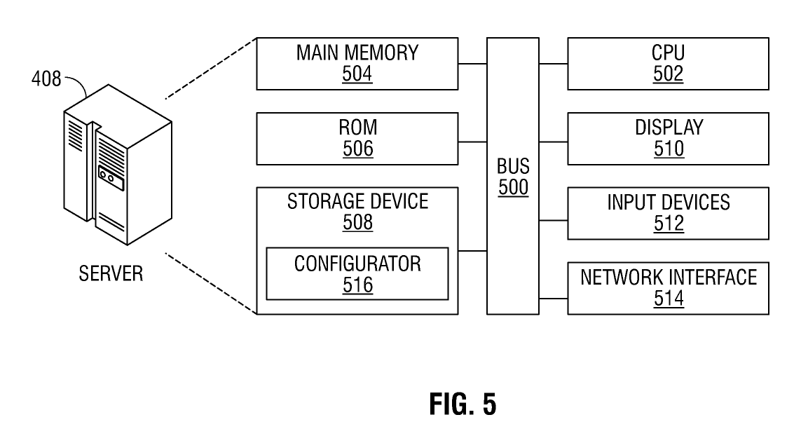

FIG. 5 illustrates an exemplary server that may be used as one of the one or more servers 408 on the computing network 406. As mentioned earlier, this server 408 may be any suitable computing system known to those having ordinary skill in the art, including a high-end server, workstation, mainframe, supercomputer, and the like, running Windows Server, Mac OS X Server, Linux, FreeBSD, Solaris, Unix, z/OS, and the like. Such a server 408 typically includes a bus 500 or other communication mechanism for transferring information within the server 408 and a CPU 502 coupled with the bus 500 for processing the information. The server 408 may also include a main memory 504, such as a random access memory (RAM) or other dynamic storage device coupled to the bus 500 for storing computer-readable instructions to be executed by the CPU 502. The main memory 504 may also be used for storing temporary variables or other intermediate information during execution of the instructions to be executed by the CPU 502. The server 408 may further include a read only memory (ROM) 506 or other static storage device coupled to the bus 500 for storing static information and instructions for the CPU 502. A computer-readable storage device 508, such as a magnetic disk or optical disk, may be coupled to the bus 500 for storing information and instructions for the CPU 502.

The term “computer-readable instructions” as used above refers to any instructions that may be performed by the CPU 502 and/or other components. Similarly, the term “computer-readable medium” refers to any storage medium that may be used to store the computer-readable instructions. Such a medium may take many forms, including, but not limited to, non-volatile media, volatile media, and transmission media. Non-volatile media may include, for example, optical or magnetic disks, such as the storage device 508. Volatile media may include dynamic memory, such as main memory 504. Transmission media may include coaxial cables, copper wire and fiber optics, including wires of the bus 500. Transmission itself may take the form of acoustic or light waves, such as those generated during radio frequency (RF) and infrared (IR) data communications. Common forms of computer-readable media may include, for example, a floppy disk, a flexible disk, hard disk, magnetic tape, other magnetic medium, a CD ROM, DVD, other optical medium, a RAM, a PROM, an EPROM, a FLASH EPROM, other memory chip or cartridge, or any other medium from which a computer can read.

The CPU 502 may also be coupled via the bus 500 to a display 510, such as a liquid crystal display (LCD), cathode ray tube (CRT), and the like for displaying information to a user. One or more input devices 512, including alphanumeric and other keyboards, mouse, trackball, cursor direction keys, and so forth, may be coupled to the bus 500 for communicating information and command selections to the CPU 502. A network interface 514 provides two-way data communication between the server 408 and other computers over the computing network 106. In one example, the network interface 514 may be an integrated services digital network (ISDN) card or a modem used to provide a data communication connection to a corresponding type of telephone line. As another example, the network interface 514 may be a local area network (LAN) card used to provide a data communication connection to a compatible LAN. Wireless links may also be implemented via the network interface 514. In summary, the main function of the network interface 514 is to send and receive electrical, electromagnetic, optical, or other signals that carry digital data streams representing various types of information.

In accordance with the disclosed embodiments, a configurator 516, or rather the computer-readable instructions therefor, may also reside on the storage device 508. The computer-readable instructions for the configurator 516 may then be executed by the CPU 502 and/or other components of the server 408 to implement new product design and design changes as described herein. Such a configurator 516 may be implemented using any suitable application development environment and programming language known to those having ordinary skill in the art. Following is a description of an exemplary implementation of the configurator 516 according to the disclosed embodiments.

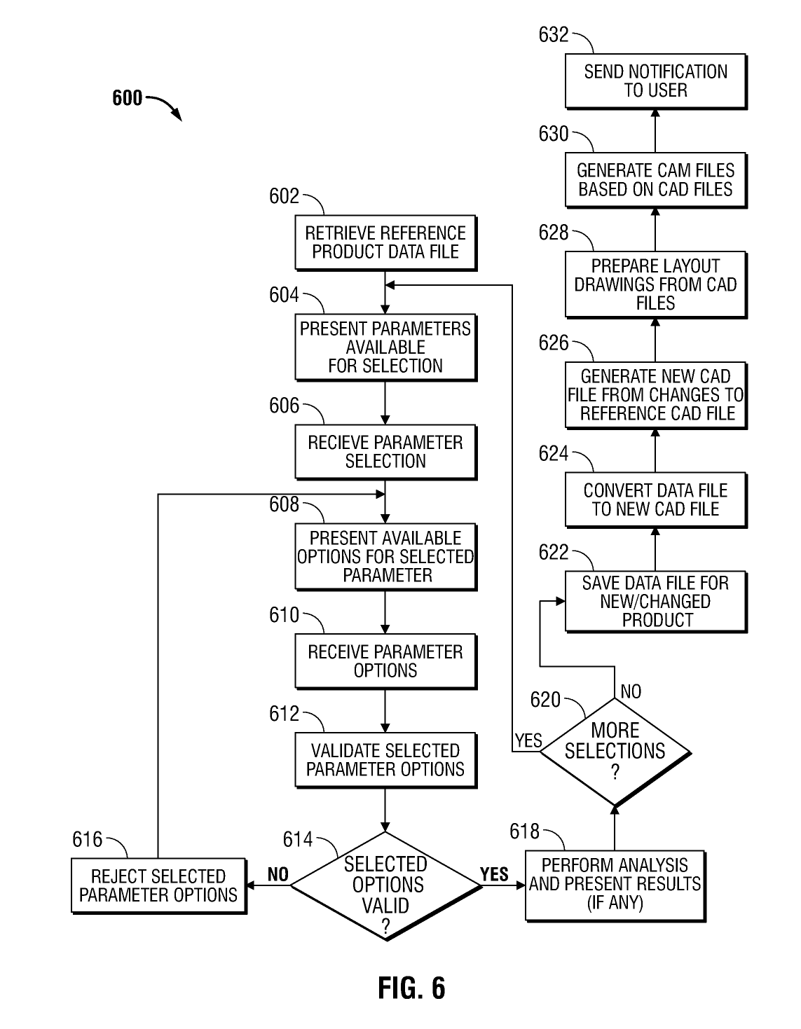

Referring next to FIG. 6, a flow chart 600 illustrates an example of a general methodology that may be used for the configurator 560. The flowchart 600 begins at block 602, where a reference product data file is retrieved from which a user may base his/her new design or design changes. In some embodiments, the reference product data file is retrieved from a library of reference data files that have been generated using a uniform set of design tools and according to a uniform set of design protocols. Such uniformity helps insure consistency between the various parameters and options therefore. In a preferred embodiment, the reference product data file is an XML file, although other file formats may certainly be used.

At block 604, various parameters that are available for modification are presented to the user, and selection of one or more parameters by the user is received at block 606. At block 608, depending on the particular parameter selected, various options that are available for that parameter are presented to the user, and selection of one or more options is received at block 610. Validation is then performed on the selected options at block 612 according to one or more predefined validation rules and/or best practices, although it should be noted that some options do not need to be validated. At block 614, a determination is made as to whether the validation is successful. If the answer is no, then the selected option is rejected at block 616 and the flowchart 600 returns to block 608 to await alternative selections by the user.

If the answer is yes, then depending on the parameters and options selected, an engineering analysis may be performed, and the results, effect, or impact of the selection presented to the user at block 618. A determination is thereafter made at block 620 to determine whether the user wishes to continue making changes at this point. If the answer is yes, then the flowchart 600 returns to block 604 to await additional selections from the user. If the answer is no, then the flowchart 600 proceeds to block 622 where the XML file containing the selections made by the user is saved as a new or modified XML file. At block 624, the modified XML file, which is essentially a “delta” file (i.e., a file composed mostly of changes or differences from an original file), is then compared to the CAD model or file for the reference product. A new CAD model or file reflecting the user's selection is generated at block 626 using the “delta” file, and layout drawings and tool paths are prepared from the new CAD file at block 628. A new CAM file is thereafter generated from the new CAD model or file at block 630. The new product design or design change may then be released to manufacturing and notification of the new part number and other information is provided to the user at block 632.

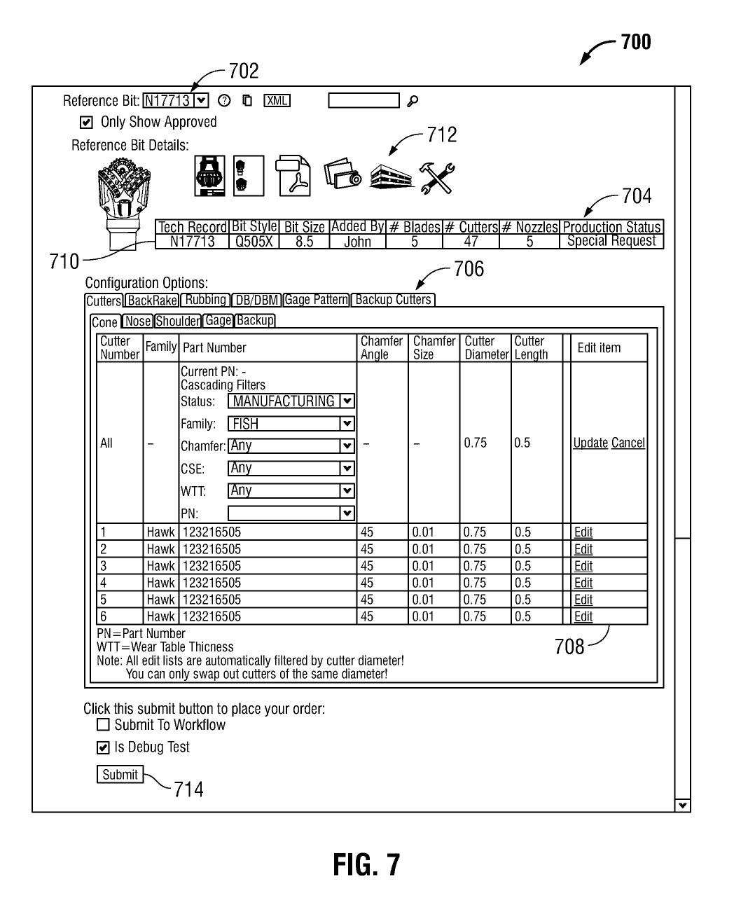

FIGS. 7-13 illustrate a plurality of screens depicting an exemplary graphical user interface for a configurator according to the disclosed embodiments. It should be noted that the particular design, color scheme, layout, selection mechanisms and overall “look-and-feel” of the graphical user interface is exemplary only, and that other designs, color schemes, layouts, selection mechanisms and so forth may be used without departing from the scope of the disclosed embodiments. It should also be noted that, although the screenshots depict an embodiment of the configurator relating to fixed cutter drill bits, the invention is not limited thereto and the principles and teachings disclosed herein are equally applicable to other types of products and in other industries.

Referring first to FIG. 7, a screen 700 is shown representing the main screen of the graphical user interface for a fixed cutter drill bit. From here, a field engineer or other user may select a reference drill bit to view using a drop-down menu 702. The details of the particular reference drill bit selected is then displayed at area 704, including a hyperlink 710 to the technical record, the bit style, bit size, number of blades, number of cutters, number of nozzles, production status, and other similar information. At area 706, various parameter configuration options for the drill bit are shown, including parameters such as the types of cutters, backrake, data bit/data bit module (DB/DBM), gage pattern, and rubbing for the drill bit. For reference, the data bit/data bit module is an option that allows an electronic recording package to be installed in the shank of the drill bit for recording real-time, high-speed dynamics motion during drilling. The data is subsequently downloaded from the drill bit and used to better understand how the drill bit performed. Other parameter configuration options known to those having ordinary skill in the art may also be used with departing from the scope of the disclosed embodiments, such as cutter specifications, cutter orientations, siderake angles, and the like.

In the present example, the selected parameter is the types of cutters, as indicated by the “Cutters” tab being active. Selecting this parameter (or tab) causes the user interface to display several sub-parameters that are specifically related to the types of cutters, including the regions of the drill bit where the cutters are located (e.g., cone, nose, shoulder, gage, backup, etc.). As will be seen later herein, selecting a different parameter causes the user interface to display a different set of sub-parameters. Within the area 706 is a list of the cutters for the reference drill bit along with specific information for each cutter, including the cutter number, family, part number, chamfer angle, chamfer size, cutter diameter, cutter length, and the like. An edit option 708 for each cutter (enumerated) allows the field engineer or other user to choose specific options for that cutter. Alternatively, by selecting “All” cutter numbers, the field engineer or other user may apply the same set of options to all the cutters. This allows the field engineer or other user to easily and conveniently swap out an entire set of cutters on the reference drill bit for a different set of cutters. The field engineer or other user may also filter the cutters in the “All” list according to their status (e.g., manufacturing), family, chamfer, CSE (secondary bevel), WTT (wear table thickness), and/or part number (PN). The selected set of options may then be applied only to those cutters that match the filter. A plurality of icons 712 allows the field engineer to review, for example, the layout drawings, style sheets, 3-D representations, photos, technical data, and the like for the drill bit. A submit button 714 allows the field engineer to submit the changes he/she has selected to the configurator.

Although not expressly shown, other parameters associated with a fixed cutter drill bit that may be configured using the configurator. These other parameters may include gage pattern, gage length, updrill cutters, backup cutters, LMM length and diameter, whether to swap casing subs, float valves, trac block, gage pad diameter, pattern and material, variable backrake, whether the drill bit will accommodate an electronic module, whether to include an electronic module, and the like.

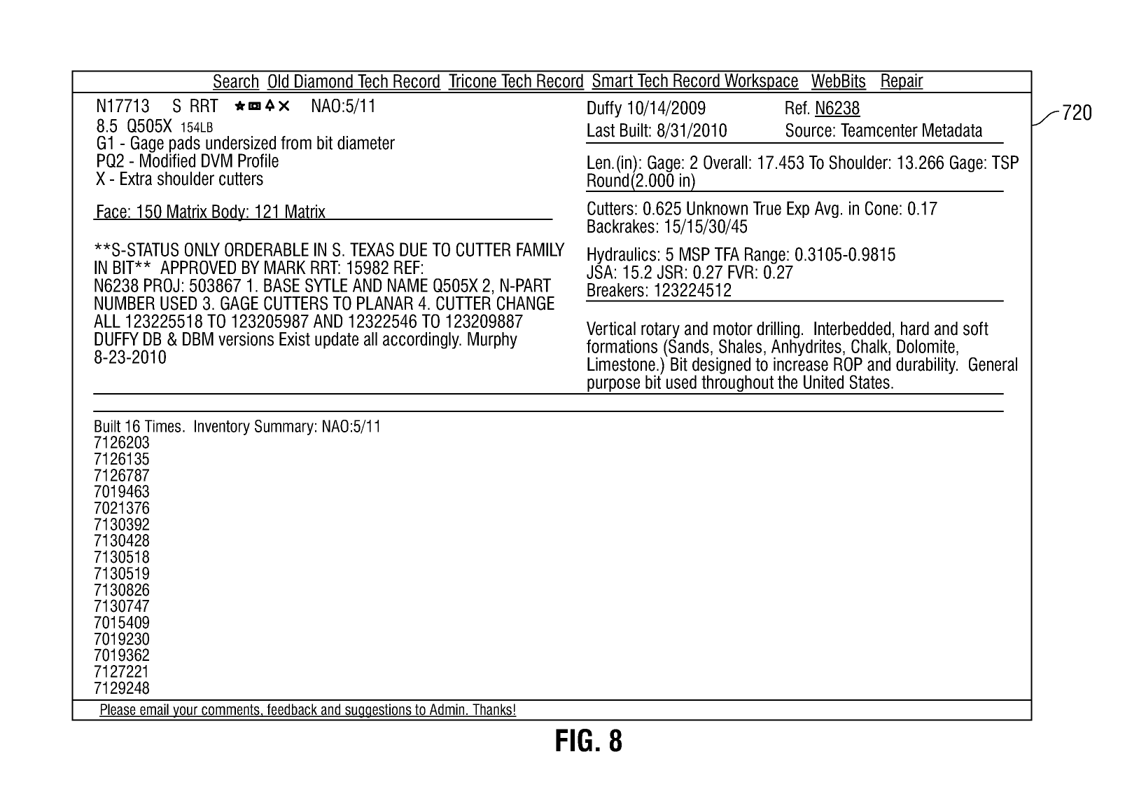

Clicking on the technical record hyperlink 710 brings up a screen 720 detailing the technical specifications for the reference drill bit, as illustrated in FIG. 8. From here, the field engineer may review in detail the various parameters for the reference bit and decide which parameters to change.

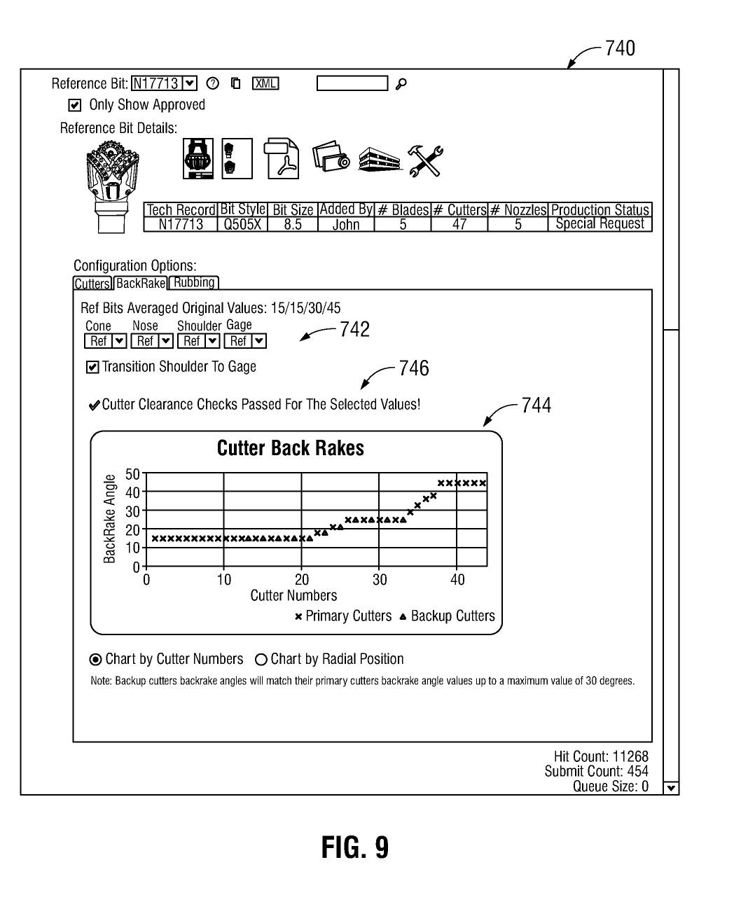

FIG. 9 illustrates a screen 740 in which the field engineer has selected a different parameter to modify, namely, the backrake angle, which is the angle formed by the cutting face of the cutter and the adjacent surface of the borehole. Selecting this parameter brings up a different set of sub-parameters that the field engineer may choose, indicated at area 742, including the backrake angle for the cutters in the cone, nose, shoulder, and gage regions. Drop-down menus or lists in this area allow the field engineer to choose the backrate angles for the cutters in these regions. Here, the term “Ref” indicates that the currently selected backrake angles are those of the reference drill bit. A graph 744 visually depicts these backrake angles for the various cutters.

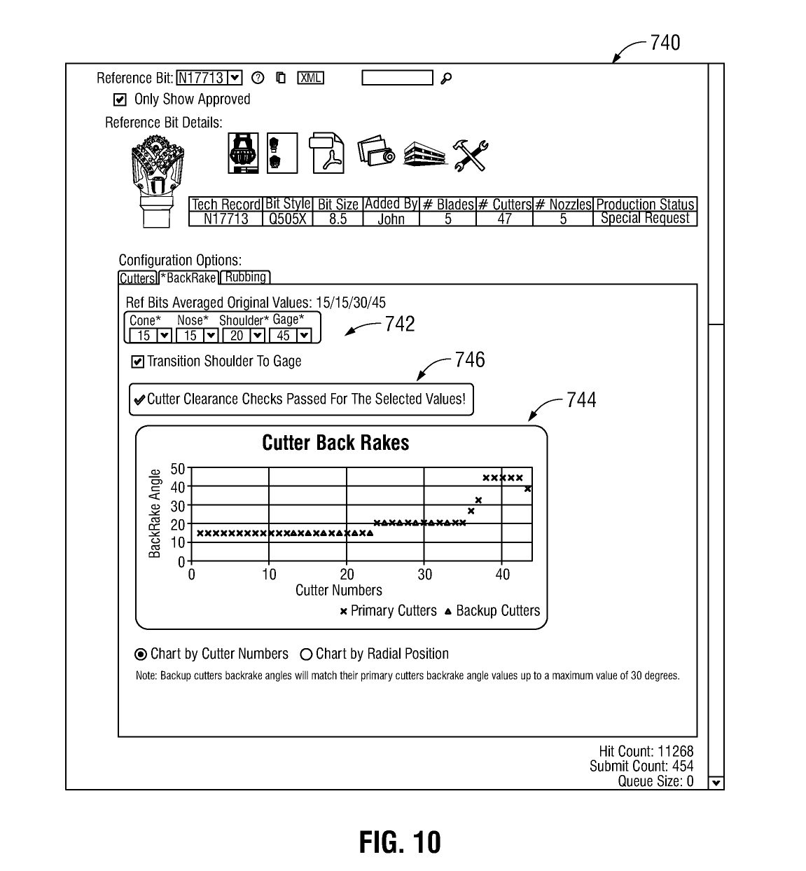

FIG. 10 shows the screen 740 from FIG. 9 in which the field engineer has changed the backrake angles for the cutters in the various regions to be different from the reference drill bit. This change is reflected in graph 744 by the configurator in real time (or near real time) so that the field engineer may graphically view the changes. In accordance with the disclosed embodiments, the configurator also performs validation for this change using one or more validation rules or best practices in real time (or near real time). The particular validation rule or best practice employed in this example is whether the new backrake angles have sufficient clearance. An appropriate indicator 746 (e.g., a checkmark) may be used to indicate whether the new backrake angles has satisfied this validation rule or best practice.

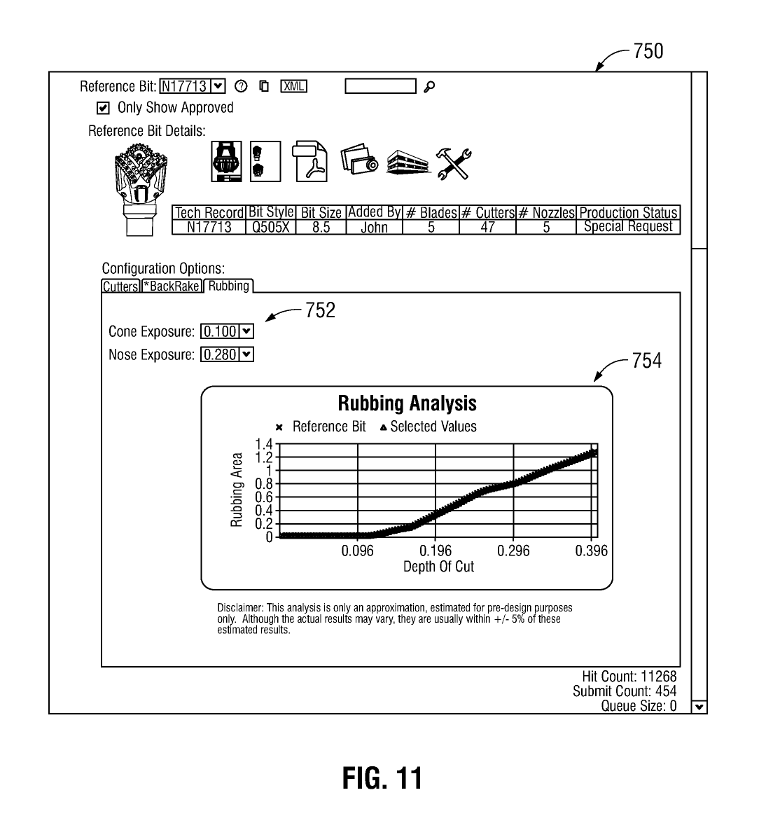

FIG. 11 illustrates a screen 750 in which the field engineer has selected yet another parameter to modify, this time the rubbing, which indicates how far the cutters extend from the body of the bit. Rubbing can affect tool face control when drilling a directional well. Selecting this parameter brings up a different set of sub-parameters from which the field engineer may choose, indicated at area 752, including the amount of exposure for the cutters in the cone and nose regions. Drop-down lists in this area allows the field engineer to choose the rubbing for the cutters in these regions. A graph 754 visually depicts an analysis of the rubbing versus depth-of-cut performed by the configurator in real time (or near real time) for the rubbing selected. Here, the graph 754 shows this analysis for the rubbing of the reference drill bit.

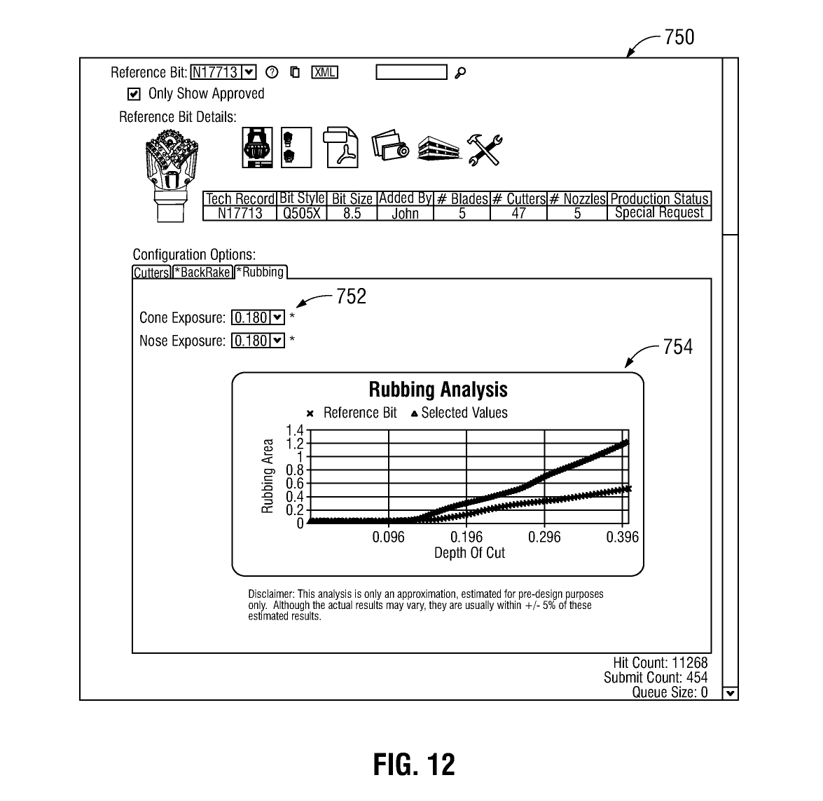

FIG. 12 depicts the screen 750 from FIG. 11 in which the field engineer has changed the rubbing for the cutters in the various regions to be different from that of the reference drill bit. The analysis for this change is again reflected in graph 754 to show the impact on depth-of-cut for both the original rubbing as well as the new rubbing in real time (or near real time) so that the field engineer may graphically compare the change.

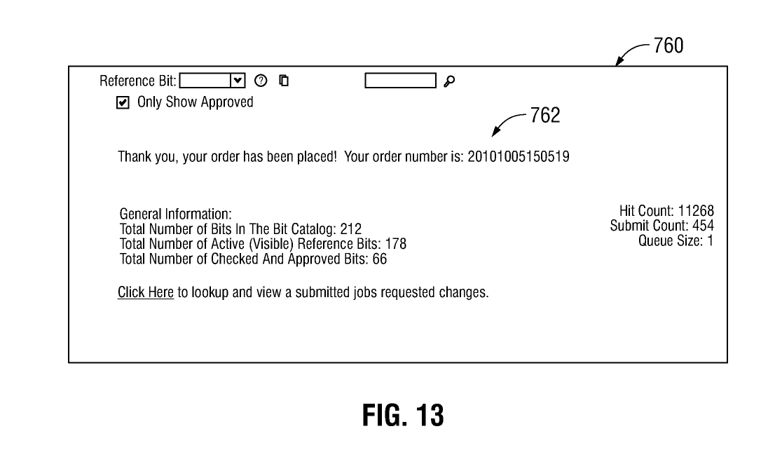

Once the field engineer has completed selecting his/her new design or design changes, he/she may submit them for implementation by clicking on the submit button 714 (see FIG. 7). Doing so causes the configurator to conduct an automated process in the background wherein all or many of the necessary tasks to implement the new design or design changes are performed in the manner described above. Upon completion of this automated process, a notification is provided either by the user interface via a screen 760, depicted in FIG. 13, or by an e-mail message to the field engineer, or both. As can be seen in FIG. 13, the notification screen 760 may include information 762, such as the part number of the new or modified drill bit and or the order number for the drill bit.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect fully all such modifications and improvements.

What is claimed is:

1. A method of implementing new product designs and design changes in real time, comprising:
presenting a plurality of design parameters for a product that are available to be changed;
receiving a selected design parameter to be changed from the plurality of design parameters;
presenting a set of options to which the selected design parameter may be changed;
receiving a selected option from the set of options;
automatically evaluating the selected option against one or more predefined validation rules and/or best practices; and
automatically generating numerically controlled manufacturing information for the product, the numerically controlled manufacturing information reflecting the selected option;
wherein the set of options to which the selected design parameter may be changed is derived from the selected design parameter.

2. The method according to claim 1, wherein the product is a fixed cutter drill bit and the plurality of design parameters include number of cutters per blade, type of cutters, backrake angle, cutter exposure, lateral movement mitigation, data bit module option, gage pattern, gage material, and rubbing for the drill bit.

3. The method according to claim 1, further comprising presenting a plurality of design sub-parameters for the product that are available to be changed based on the selected design parameter, wherein each selected design parameter has a separate set of design sub-parameters associated therewith.

4. The method according to claim 1, further comprising automatically generating a three-dimensional graphical representation of the product, the three-dimensional graphical representation reflecting the selected option.

5. The method according to claim 1, wherein the selected option is automatically evaluated against the one or more predefined validation rules and/or best practices based on an intended application of the product.

6. The method according to claim 1, wherein the automatic evaluation includes making one or more options unavailable for selection based on the selected option and/or the selected design parameter.

7. The method according to claim 1, wherein the automatic evaluation includes conducting a performance analysis for the product based on the selected option.

8. A system for allowing users to request new product designs and design changes from a remote location, comprising:
a network accessible by a user from the remote location;
a database connected to the network, the database storing design parameters for the product and options for each design parameter; and
a server connected to the database, the server including a processor and a storage medium, the storage medium storing computer-readable instructions that are executable by the processor for causing the server to:
present a set of design parameters for the product that are available to be changed to the user;
receive a selected design parameter to be changed from the set of design parameters from the user;
present a set of options to which the selected design parameter may be changed to the user;
receive a selected option from the set of options from the user;
automatically evaluate the selected option against one or more predefined validation rules and/or best practices; and
automatically generate numerically controlled manufacturing information for the product, the numerically controlled manufacturing information reflecting the selected option;
wherein the set of options to which the selected design parameter may be changed is derived from the selected design parameter.

9. The system according to claim 8, wherein the product is a fixed cutter drill bit and the plurality of design parameters include number of cutters per blade, type of cutters, backrake angle, cutter exposure, lateral movement mitigation, data bit module option, gage pattern, gage material, and rubbing for the drill bit.

10. The system according to claim 8, wherein the computer-readable instructions are executable by the processor for further causing the server to present a plurality of design sub-parameters for the product that are available to be changed based on the selected design parameter, wherein each selected design parameter has a separate set of design sub-parameters associated therewith.

11. The system according to claim 8, wherein the computer-readable instructions are executable by the processor for further causing the server to automatically generate a three-dimensional graphical representation of the product, the three-dimensional graphical representation reflecting the selected option.

12. The system according to claim 8, wherein the selected option is automatically evaluated against the one or more predefined validation rules and/or best practices based on an intended application of the product.

13. The system according to claim 8, wherein the automatic evaluation includes making one or more options unavailable for selection based on the selected option and/or the selected design parameter.

14. The system according to claim 8, wherein the automatic evaluation includes conducting a performance analysis for the product based on the selected option.

15. A method for allowing a user to generate new drill bit designs and drill bit design changes on-the-fly, comprising:
presenting a plurality of drill bit design parameters that are available to be changed to the user;
receiving a selected drill bit design parameter to be changed from the plurality of drill bit design parameters from the user;
presenting a set of drill bit design options to which the selected drill bit design parameter may be changed to the user;
receiving a selected drill bit design option from the set of drill bit design options from the user;
evaluating the selected drill bit design option against one or more predefined drill bit design validation rules and/or best practices; and
automatically generating numerically controlled manufacturing information for the drill bit, the numerically controlled manufacturing information reflecting the selected drill bit design option;
wherein the set of drill bit design options to which the selected design parameter may be changed is derived from the selected drill bit design parameter.

16. The method according to claim 15, wherein the drill bit is a fixed cutter drill bit and the plurality of design parameters include number of cutters per blade, type of cutters, backrake angle, cutter exposure, lateral movement mitigation, data bit module option, gage pattern, gage material, and rubbing for the drill bit.

17. The method according to claim 15, further comprising presenting a plurality of design sub-parameters for the drill bit that are available to be changed based on the selected drill bit design parameter, wherein each selected drill bit design parameter has a separate set of drill bit design sub-parameters associated therewith.

18. The method according to claim 15, further comprising automatically generating a three-dimensional graphical representation of the drill bit, the three-dimensional graphical representation reflecting the selected drill bit design option.

19. The method according to claim 15, wherein the selected option is automatically evaluated against the one or more predefined validation rules and/or best practices based on an intended application of the drill bit.

20. The method according to claim 15, wherein the automatic evaluation includes making one or more drill bit design options unavailable for selection based on the selected drill bit design option and/or the selected drill bit design parameter.

21. The method according to claim 15, wherein the automatic evaluation includes conducting a performance analysis for the drill bit based on the selected drill bit design option.
